(19) United States
(12) Patent Application Publication
(10) Pub. No.: US 2022/0026056 A1
(43) Pub. Date: Jan. 27, 2022

(54) Lamp with Phone Holder and Charger

(71) Applicants: Ramona Smith, Enid, OK (US); Joe Smith, Enid, OK (US)

(72) Inventors: Ramona Smith, Enid, OK (US); Joe Smith, Enid, OK (US)

(21) Appl. No.: 17/372,665

(22) Filed: Jul. 12, 2021

Related U.S. Application Data
(60) Provisional application No. 63/055,976, filed on Jul. 24, 2020.

(51) Int. Cl. F21V 33/00; F21V 21/088; F21V 17/02; F21V 21/22; F21V 23/04; F21S 9/02; F21V 23/06; H02J 7/00; H04B 1/3877

(52) U.S. Cl. CPC F21V 33/0052; F21V 21/088; F21V 17/02; F21V 21/22; H04B 1/3877; F21S 9/02; F21V 23/06; H02J 7/0044; F21V 23/04

(57) ABSTRACT

This present invention relates to a modified lamp device having an electronic device holder and a charger for charging the electronic device mounted on the holder. The lamp device features a telescopic stand, rotation adjustment mechanism, USB port, battery, AC/DC adapter, wireless communication modules and others features, and enables a user to charge the mounted electronic device while the same is mounted on the stand, and while operating the lamp device.

### CROSS-REFERENCE TO RELATED APPLICATION

The present application claims priority to, and the benefit of, U.S. Provisional Application No. 63/055,976, which was filed on Jul. 24, 2020 and is incorporated herein by reference in its entirety.

### BACKGROUND OF THE INVENTION

The present invention relates generally to the field of household and office accessories. More specifically, the present invention relates to a modified lamp for a desk or table that features an integrated holder or support for a smartphone or tablet, and a USB plug or connection to enable a user to charge any electronic device that is mounted on or otherwise supported by the holder. The modified lamp assembly further includes a 360-degree rotating clip to rotate the mounted smart device about the lamp assembly for the convenience of the user, and a height adjustment mechanism for adjusting the height of the mounted device so that the same may be mounted at the user's eye level. Accordingly, the present specification makes specific reference thereto. However, it is to be appreciated that aspects of the present invention are also equally amenable to other like applications, devices and methods of manufacture.

By way of background, electronic devices such as smartphones, tablets and the like are widely used by individuals for a variety of purposes including, without limitation, both entertainment and work. Individuals also use such devices for viewing films or movies, amusement and recreation, games, video calls, and the like, which can occupy the individual for prolonged periods of time, as well as drain the device's battery. Further, holding such devices with the individual's hands for prolonged periods of time may cause numbness or pain in the individual's hands, ache in the neck, cervical vertebra stiffness, cold shoulders, and other detrimental health effects that may contribute to long term health issues. Accordingly, individuals oftentimes place such devices on a table, desktop, or other surface to liberate both hands and prevent themselves from pain caused due to prolonged use and holding of the electronic device. However, if not properly clamped or mounted on the desktop or other surface, the device may slide off of the same and become damaged. Additionally, the need for a user to continuously reposition a secured device is also time consuming and frustrating for the user.

Furthermore, while using electronic phones and tablet devices, a user will typically tilt his or her head downwardly at an angle to view the screen of such electronic devices, which may result in “text neck.” Text neck is a modern age term used to describe repeated stress injury and pain in the neck resulting from excessive watching or texting on handheld devices over a sustained period of time. In order to avoid developing text neck, a user should attempt to always view the screen of the device at a predefined height (preferably at normal eye level), and not at an inclined angle. In an effort to avoid text neck, some users will prop the device on an object, such as a book, plate, or other item which the user may find nearby. When the user mounts the device on a desktop or on any other prop, the device is mounted at a predefined height. However, if the user needs to change the height of the device to set the device screen at eye level or to meet any other requirement, the user typically has to search for other props to build up the height, which causes inconvenience to the user.

Additionally, most electronic devices may have limited battery life, and require frequent charging while in use, such as when watching a movie or video chatting. Most wired charging mechanisms require a user to plug the device into a power source, which may make it difficult for the user to use the device while it is being charged, depending upon the location of the electrical outlet, the length of the charging cord, etc. Also, the presence of the charging cord may make it difficult for the user to properly mount the device at the appropriate height and/or position to avoid text neck.

Various mounting stands are available in the market for supporting an electronic device, but suffer from a number of limitations. For example, such mounting devices typically do not allow the user to adjust the height of the device mounted on the stand to suit the user's needs and/or preferences. Also, when a device is mounted on the prior art mounting stands, the angle of viewing of the screen of the device is fixed and typically cannot be changed, which is also an inconvenience to the user. Further, most mounting stands limit the number of compatible devices that can be clamped and held by the device, and cannot be used for mounting different types of devices. For example, one stand may be required for clamping and supporting a mobile device, and a separate stand may be required for clamping a larger or differently shaped device, such as a tablet device. Buying separate mounting stands for different devices adds to the overall cost and storage requirements of the user, and is not ideal. Moreover, such mounting stands typically do not include a lighting source for illuminating the device and/or surrounding area, such as a workspace.

Therefore, there exists a long felt need in the art for a mounting device for securely clamping and holding a plurality of different electronic devices, such as mobile phones, tablets, laptops and the like, having different sizes and/or shapes. There is also a long felt need in the art for a mounting device that has an integral light source for easier viewing of the device and the surrounding workspace. Moreover, there is a long felt need in the art for a device mounting stand that enables a user to adjust the height and/or viewing angle of the electronic device attached to the mounting stand to better suit the user's needs and/or preferences. Additionally, there is a long felt need in the art for a device mounting stand that enables a user to charge the electronic device while mounted, and that allows the user to use the device while it is being charged. Finally, there is a long felt need in the art for a device mounting stand that is relatively inexpensive to manufacture, aesthetically pleasing, and safe and easy to use.

The subject matter disclosed and claimed herein, in one embodiment thereof, comprises a modified lamp featuring an integrated smartphone or tablet holder, and a device charging mechanism. The modified lamp assembly includes a size adjusting base for securely clamping different sized and/or shaped electronic devices to the base. Further the lamp assembly includes a telescopic stand, and a height adjuster mechanism for adjusting the height of the mounted device as per the preferences of the individual user. The device further includes a 360-degree rotatable clip or support that enables a user to adjust the position of the mounted device with ease.

In this manner, the modified lamp and stand assembly of the present invention accomplishes all of the forgoing objectives, and provides a relatively easy solution to the historic difficulties associated with mounting differently sized and/or shaped electronic devices while maintaining access to electrical power to charge the device and a lighting source. The modified support and lamp device of the present invention is also user friendly inasmuch as it provides the user with the ability to quickly and easily adjust the height and/or position of the mounted electronic device, charge the electronic device while the same is being used, and illuminate the device and its surroundings, all in a single and easy to use device.

### SUMMARY OF THE INVENTION

The following presents a simplified summary in order to provide a basic understanding of some aspects of the disclosed innovation. This summary is not an extensive overview, and it is not intended to identify key, critical elements or to delineate the scope thereof. Its sole purpose is to present some concepts in a simplified form as a prelude to the more detailed description that is presented later.

The subject matter disclosed and claimed herein, in one embodiment thereof, comprises a modified lamp device mounted on a telescopic stand having a lamp for providing light, an electronic device holding plate having an adjustable width, a charging mechanism for charging the mounted electronic device, and a rotating knob to enable 360 degree rotation of the mounted device to suit user need and/or preference. The devices further comprises a height adjustment mechanism to enable the user to easily adjust the height of the mounted device so that it may be maintained at the user's eye level.

In an alternative embodiment, the subject matter disclosed and claimed herein comprises a lamp device with an integrated phone holder and a charger. More specifically, the lamp device comprises a stand, a lamp mounted on the stand, a mounting plate placed on a top end of the stand, and a USB port in electrical communication with a power source for charging the phone. The mounting plate is preferably comprised of two clips for clamping an electronic device (e.g., a phone) between the clips, and the mounting plate has grooves for adjusting the width of the clips to accommodate different types of electronic devices, or those having different sizes. In a further alternate embodiment, a wireless charging pad may also be provided at the base of the mounting plate to provide wireless charging capabilities for the various mounted electronic devices.

In a further embodiment of the present invention, the lamp device comprises a rechargeable battery or other portable power source that enables the lamp device to operate without plugging into an external hardwired power source. The battery also provides power to the USB port to charge the mounted electronic device. Further, the unique arrangement of the combination lamp and mounting device of the present invention enables the mounted electronic device to be easily charged regardless of the height and/or position at which the electronic device is mounted. The modified lamp device may also support an AC/DC adaptor to power the lamp device, as well as to charge the mounted electronic device, when a traditional power source is available, thereby conserving battery life.

In yet another embodiment of the present invention, a method of accessing a modified lamp and mounting device is disclosed. The method comprises the steps of initially adjusting the size of the mounting means by increasing or decreasing a distance between two clips of a mounting plate and then mounting an electronic device on the mounting plate. Next, a height of the mounting plate of the lamp device is adjusted by using a height adjustment mechanism to ensure that the electronic device is at an approximate eye level of a user. Next, an angle of rotation of the mounted electronic device is determined by using a rotation adjusting mechanism to suit the user's preference. The individual user may then plug the electronic device into a USB port integrated into the stand of the device to charge the electronic device and/or utilize the integrated lamp to provide light to the device and/or the surrounding area.

In a further exemplary embodiment of the present invention a combination support and smart device is disclosed and comprises a smart device that has a size and shape and a support, wherein the support is comprised of a housing with a base at one end and a mounting support provided at another end opposite the base. The housing is extendable and retractable via a telescoping adjusting mechanism. The mounting support has a surface and first and second clips defining a space, with the space being adjustable to accommodate the size and shape of the smart device, wherein the mounting support is movable in both the horizontal and vertical planes. The combination device further comprises an illumination device that is connected to the housing and the support, and is comprised of a USB port and a battery.

In a yet still further exemplary embodiment of the present invention, an illumination device and smart device holder system is disclosed and includes a smart device and a wireless wristband having a wireless transmitter. The system also includes a holder having a stand with first and second ends, a base applied at the first end, and a mounting support positioned at the second end. The mounting support is adjustable in both a horizontal plane and a vertical plane, and the stand is adjustable in height and further comprises an illumination source. The stand has a wireless receiver to communicate with the transmitter of the wristband, wherein the wristband may be used to adjust the height of the stand and a position of the mounting support in at least one of the horizontal or vertical planes.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one possible embodiment of a modified lamp device of the present invention in accordance with the disclosed architecture and comprising a smart device holder and a charger for charging a smart device.

FIG. 2 illustrates a perspective view of one possible embodiment of a modified lamp device of the present invention in accordance with the disclosed architecture and comprising a smartphone securely mounted thereon and being charged by the device.

FIG. 3 illustrates a perspective view of one possible embodiment of the mounting plate of the modified lamp device of the present invention in accordance with the disclosed architecture.

FIG. 4 illustrates a perspective view of one possible embodiment of the mounting plate of the modified lamp device of the present invention in accordance with the disclosed architecture, wherein the mounting plate is pivoted from a vertical axis of the stand.

FIG. 5a illustrates a top perspective view of a portion of one possible embodiment of the mounting plate of the modified lamp device of the present invention in accordance with the disclosed architecture, wherein the mounting plate is further comprised of a grooved gripping surface.

FIG. 5b illustrates a side elevational view of a portion of one possible embodiment of the mounting plate of the modified lamp device of the present invention in accordance with the disclosed architecture, wherein the mounting plate is further comprised of a grooved gripping surface.

FIG. 6 illustrates a partial perspective view of one possible embodiment of the modified lamp device of the present invention in accordance with the disclosed architecture, wherein the lamp portion of the device is remotely controlled by a wristband.

### DETAILED DESCRIPTION OF THE INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long felt need in the art for a combination lamp and mounting device for securely clamping and holding a plurality of different electronic devices, such as mobile phones, tablets, laptops and the like, having different sizes and/or shapes, and illuminating the same and the surrounding workspace. Moreover, there is a long felt need in the art for a device mounting stand that enables a user to adjust the height and/or viewing angle of the electronic device attached to the mounting stand to better suit the user's needs and/or preferences. Additionally, there is a long felt need in the art for a combination lamp and mounting device that enables a user to charge the electronic device while mounted, and that allows the user to use the device while it is being charged. Finally, there is a long felt need in the art for a combination lamp and mounting device that is relatively inexpensive to manufacture, that is aesthetically pleasing, and that is safe and easy to use.

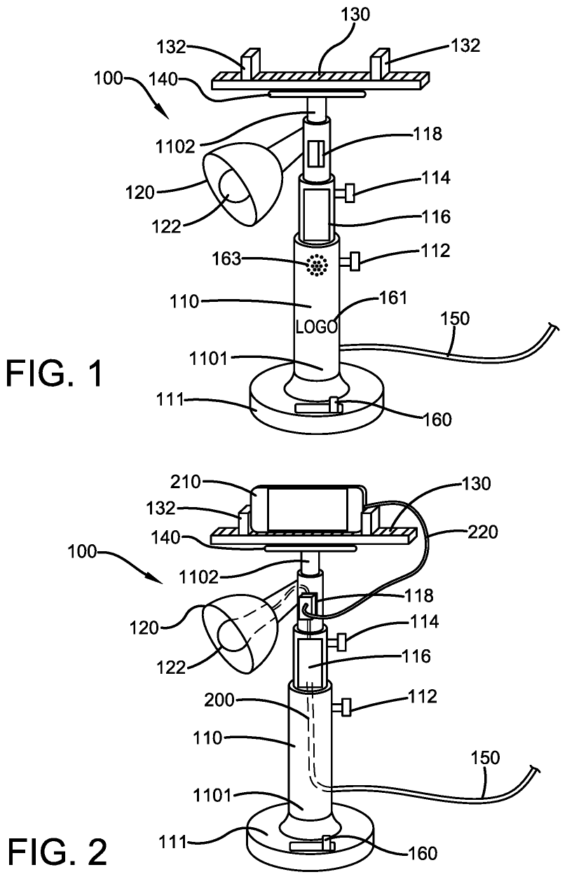

Referring initially to the drawings, FIG. 1 illustrates a perspective view of one possible embodiment of a modified lamp device 100 of the present invention in accordance with the disclosed architecture, and comprising a smart device holder or mounting plate 130 and a charging means 118 for charging a smart device. More specifically, the combination lamp and mounting device 100 comprises a light or illumination source 122 having a lamp shade 120, a stand 110 for mounting the light source 122 thereon, a mounting plate 130 for mounting an electronic device, such as a phone, tablet or the like, a height adjustment mechanism 112, a rotation adjustment mechanism 114, a rotating plate 140, a power supplying wire 150, a switch 160, a battery 116 and a USB port 118.

The stand 110 has a bottom end 1101 connected to a support or a base 111 for securely supporting the lamp assembly 100 on a surface (e.g., a table, desk, counter, etc.), and a top end 1102 that is attached to the mounting plate 130. The base 111 may be weighted to provide additional stability to the device 100, and to prevent the device 100 from tipping over when the smart device is mounted onto the mounting plate 130. While FIGS. 1 and 2 depict the base 111 as being generally circular in configuration, base 111 may take any other geometric shape such as a square, rectangular, pentagonal, star, etc., or a non-geometrical shape. Further, the dimensions of the base 111 are preferably larger than the dimensions of the mounting plate 130, and more preferably one and one half to two times larger than the dimensions of the mounting plate 130 for additional stabilization.

A sliding switch 160 for operating the modified lamp assembly 100 is preferably integrated into the base 111. More specifically, the switch 160 may operate between different modes to turn ON/OFF the light or illumination device 120, turn ON/OFF charging of the mounted device through the USB port 118, and/or to operate the lamp device 120 and the USB charging feature together. Notwithstanding, the switch 160 for operating the lamp device 100 is not so limited, and other operating switches known in the art (e.g., separate buttons, a touch panel, etc.) can be used as well.

The stand 110 of the modified lamp device 100 is preferably telescopic, wherein a height of the stand 110 is adjustable using the integrated height adjusting mechanism 112. The integrated height adjusting mechanism 112 may be a button, knob, lever or any other means that enables a user to increase or decrease the height of the stand 110, thereby increasing or decreasing the height of the mounted electronic device, for example, to position the same at a user's eye level. For example, in one embodiment of the present invention, the height of the stand 110 can be adjusted in a range from about 6 inches to 4 feet, with about 1 foot to 2 feet being preferred for a table top version, and up to 4 feet being preferred for a floor version of the combination lamp and mounting device 100. Nonetheless, it should be understood that the range of motion of the combination lamp and mounting device 100 is not so limited, and that the structure of the telescopic stand 110 can be defined to suit user need and/or preference.

As previously stated, smart devices, such as a smartphone, tablet or the like, can be easily mounted on the mounting plate 130 of the combination lamp and mounting device 100. Further, the rotation adjustment mechanism 114 is integrated into the structure of the stand 110, and functions in coordination with the rotating plate 140 connected to, and positioned below, the mounting plate 130. The rotation adjustment mechanism 114 may be a knob, rolling button, toggle switch or lever, or any other means that enables the user to set a viewing angle for the mounted electronic device as per the preferences of the individual user. More specifically, the rotation adjustment mechanism 114 allows 360-degree rotation of the rotating plate 140 (and therefore the mounting plate 130) to suit different user requirements. The setting of the rotation adjustment mechanism 114 triggers or releases the rotating plate 140 to change its angle to rotate the mounting plate 130, and therefore rotate the electronic device, such as a smartphone or tablet device mounted on the mounting plate 130. The mounting plate 130 moves both in the “X” axis (i.e., horizontal in relation to the floor) so that the mounting plate 130 may be rotated 360° about a vertical or longitudinal axis of the stand 110, as well as in the “Y” axis (i.e., vertical in relation to the floor or horizontal plane), so that the plate may be tilted up to 90° degrees from the vertical or longitudinal axis of the stand 110 to allow for different viewing positions, regardless of where the user is standing or seated in the room.

As previously stated, a USB port 118 is integrated into the stand 110, preferably near the top end 1102 of the stand 110, and is in electrical communication with a battery 116 or external power source for supplying power to the electronic device, such as a mobile phone, tablet, etc., connected to the USB port 118. More specifically, the mounted electronic device can be plugged in to the USB port 118 though a compatible USB cable 220. Electrical power is then supplied from the battery 116 or other external power source to the mounted electronic device via the USB cable 220. The modified lamp device 100 may also include an AC/DC adapter for converting the AC power supplied from an external source, such as wall-outlet, to a DC power for the operation of the lamp device 100 and/or the charging of the smart device. Accordingly, the lamp device 100 preferably includes a wired plug 150 to connect the lamp assembly 100 directly to an external power source, such as a wall outlet.

Furthermore, the battery 116 may be a rechargeable battery which can be charged by plugging the lamp device 100 into an external power source, or it can be charged separately. By way of example, the lamp device 100 may be powered by one or more nickel metal hydride (NiMH) batteries, or by any other type of battery known in the state of the art. However, a NiMH battery has properties that reduce the probability of overheating, and decrease the recharging requirements versus using lithium-ion or lithium polymer batteries (LiPo). The lamp device 100 may also comprise one or more solar panels (not shown) for the operation of the device 100, and to recharge the battery 116. The battery 116 may be housed in the stand 110, the base 111, or elsewhere on the combination lamp and mounting device 100.

In an embodiment of the present invention, the stand 110 may be made up of plastic, metal, wood or any other suitable material, as per the preferences of the manufacturer or user. The stand 110 may be an elongated firm structure, or may be a flexible pole-like structure as per the preferences and requirements of the user. Additionally, the combination lamp and mounting device 100 may be of any color suitable to the user, and may also comprise a logo, trademark, emblem 161, or other insignia, etc. to further accessorize the device 100, as best shown in FIG. 1.

In a further embodiment of the present invention, the modified lamp device 100 may include speakers 163 for amplifying the sound received from the mounted mobile device or tablet device connected to the USB port 118. The speakers 163 may be built into the device 100, wirelessly connected to the device 100, or there may be an additional port on the device 100 to plug in separate speakers. The speaker(s) 163 enhance the experience of the users while watching movies, streaming videos, and the like. Other LED indicators may also be included on the stand 110 or the base 111 to, for example, indicate the status of different features of the device. Further, the light source 122 may be a bulb, an LED light, an incandescent light, a florescent light, a CFL light source, or any other form of light source which may be turned on or off by the switch, a sensor, remote control, or wireless, blue-tooth, or Wi-Fi controller with an software application on a device.

FIG. 2 illustrates a perspective view of one possible embodiment of a modified lamp device 100 of the present invention in accordance with the disclosed architecture and comprising a smartphone 210 securely mounted thereon and being charged by the device. More specifically, the modified lamp device 100 may comprise internal wiring 200 that connects the various electronic components, such as the light source 122, USB port 118, battery 116, AC/DC adapter, and the like, as well as a housing that is hollow to allow for the wiring and other connections to be contained safely within the housing. The power supplied through an external source via a wired plug 150 is converted from an AC current to DC current for use by the lamp device 100. The current is supplied to different components such as the light source 122, USB port 118 and battery 116 through the internal wiring 200. As also best shown in FIG. 2, an electronic device such as a mobile phone 210 may be mounted horizontally over a mounting plate 130. The mobile phone 210 is connected to the USB port 118 through a compatible USB cable 220 for supplying power to the phone 210 or to recharge the same.

The base 111 of the lamp device 100 includes a switch 160 which can slide over a slidable plate to select an operational mode for the modified lamp device 100. For example, in a first mode, the switch 160 is set to turn ON the light source 122 of the lamp device 100. In a second mode, the switch 160 is set to turn ON the charging feature for the USB port 118. In a third mode, the switch 160 is set to turn ON the light source 122 and the charging feature for the mounted electronic device 210 together. In a fourth mode, the switch 160 turns OFF the modified lamp device 100. In all the modes of operation of switch 160, the power can be supplied either by an external power source (e.g., a wall outlet) or by an integrated battery 116 which may be provided internally or externally on the device 100.

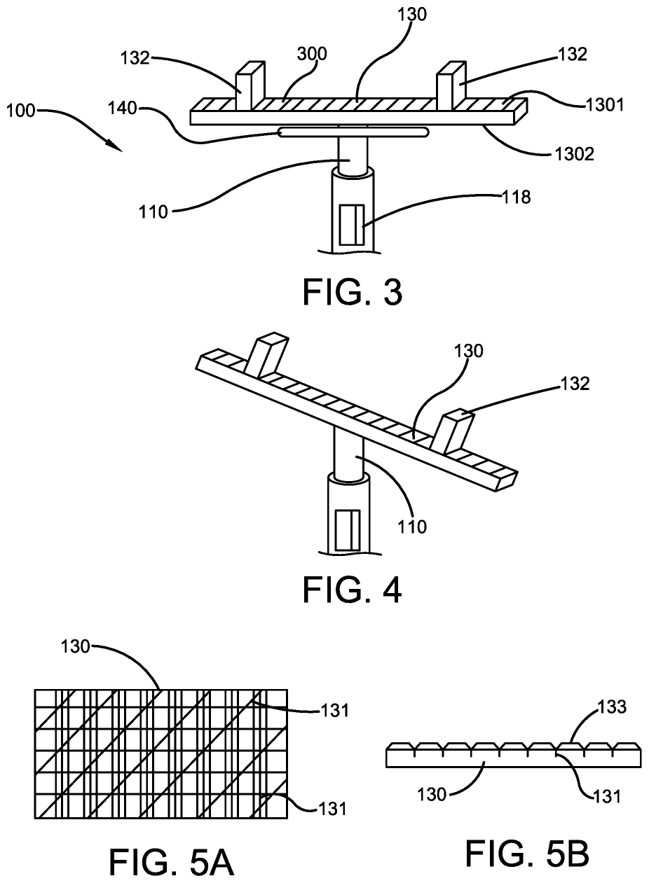

FIG. 3 illustrates a perspective view of one possible embodiment of the mounting plate 130 of the modified lamp device 100 of the present invention in accordance with the disclosed architecture. More specifically, the device 100 comprises an adjustable mounting plate 130 to accommodate different electronic devices such as mobile phones, tablets or the like. The mounting plate 130 provides a support for holding the mounted electronic device, and is preferably comprised of two repositionable clips 132 for adjusting the size of the mounting plate 130 to accommodate the particular electronic device to be mounted in the manner shown in FIG. 2. The mounting plate 130 is further comprised of a plurality of grooves 300 created on the upper surface 1301, and is attached to the rotating plate 140 along a lower surface 1302 of the plate 130. In FIG. 3, the plurality of grooves 300 are shown as being generally perpendicular to the transverse edges of the mounting plate 130, but it should be understood that the grooves 300 may be parallel to the transverse edges or long sides of the plate, run diagonally, or any combination thereof, including a hatch pattern. The rotating plate 140 is mechanically attached to the mounting plate 130, so as to rotate the mounting plate 130 based on the input received through the rotation adjustment means 114. The rotating plate 140 can be directly or indirectly attached to the mounting plate 130 by any attaching means known in the art, such as a screw, ratchet, pin, rod, or other fastener that does not interfere with the ability of the rotating plate 140 to rotate about the stand 110.

The mounting plate 130 can be a rectangular plate, a cylindrically shaped disc or any other shape or configuration that is capable of being rotated 360-degrees clockwise or counter-clockwise. The mounting plate 130 provides a rotating platform for an electronic device mounted over the plate 130. The mounting plate 130 may also be pivoted from the vertical “Y” axis up to 90° to accommodate different viewing angles to suit user need and/or preference. For example, FIG. 4 illustrates a perspective view of one possible embodiment of the mounting plate 130 of the modified lamp device 100 of the present invention in accordance with the disclosed architecture, wherein the mounting plate 130 is pivoted from a vertical axis of the stand 110. Also, the clips 132 are repositionably spaced apart relative to one another on the mounting plate 130 to accommodate any size of electronic device, and secure the same, for example, when mounting plate 130 is pivoted as described above.

In a further embodiment of the present invention, the mounting plate 130 of the lamp device 100 may include a wireless charging pad (not shown) for providing a charging feature for any compatible wireless charging devices or Qi-enabled devices mounted on the mounting plate 130. In such a scenario, the wireless charging pad may be charged using an external power supply or through the batteries of the modified lamp assembly 100. The wireless charging pad charges the mounted compatible electronic device without any of the associated difficulties of wired charging.

The clips or clamping element 132 are attached to both the ends of the mounting plate 130 of the lamp device 100. As previously mentioned, the adjustable clamping element 132 can be expanded and retracted over the grooves 131 in the mounting plate 130 to attach different size smartphones to the adjustable mounting plate 130. More specifically, a force can be applied to expand the adjustable clips 132 in a distance opposite one another, such that the distance between the clips 132 is increased to accommodate a larger size of electronic device. Similarly, a force may be applied to the adjustable clips 132 to bring them closer to one another, such that the distance between the clips 132 is decreased to accommodate a smaller size of electronic device. The adjustable clips 132 secure the mounted electronic device in place, and prevents the same from sliding off of the mounting pad 130. Once properly positioned, the adjustable clips 132 may be snapped into the grooves 131, or snapped onto the edges of the mounting plate 130. Alternatively, the adjustable clips 132 may be set into pre-drilled slots or holes to accommodate standard sizes of electronic devices.

In yet a further embodiment of the present invention, the upper surface 1301 of the mounting plate 130 may include a gripping material to provide a better grip for the mounted electronic device. For example, FIG. 5a illustrates a top perspective view of a portion of one possible embodiment of the mounting plate 130 of the modified lamp device 100 of the present invention in accordance with the disclosed architecture, wherein the mounting plate 130 is further comprised of a grooved gripping surface 133. FIG. 5b illustrates a side elevational view of a portion of one possible embodiment of the grooves 131 and gripping surface 133 of mounting plate 130 in accordance with the disclosed architecture. The gripping material 133 can also be applied to a portion of the adjustable clips 132, or the entirety of the adjustable clips 132 can be made of the gripping material. The gripping material 133 can be any material that increases the adhesion, grip or coefficient of friction between the gripping surface of the clips 132 and a surface of a device secured within the adjustable clips 132. For example, the gripping material 133 can include, but is not limited to, a rubber, polymeric material or other plastic, metal, alloy, fabric, composite material or other material capable of increasing the adhesion, grip or coefficient of friction between the gripping surface of the adjustable clips 132 and a surface of a device secured within the adjustable clips 132. The gripping material and gripping surface 133 can also be textured and comprised of the same or different material. Ideally, the gripping surface 133 would provide a coefficient of friction for kinetic energy ranging from 0.5μ to 0.8μ.

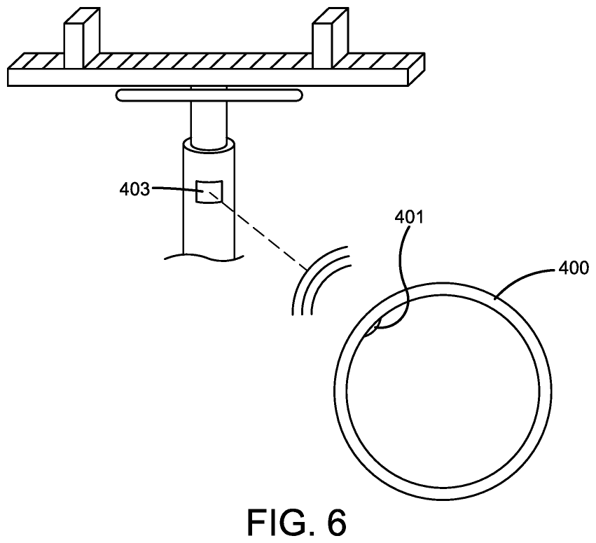

FIG. 6 illustrates a partial perspective view of one possible embodiment of the modified lamp device 100 of the present invention in accordance with the disclosed architecture, wherein the lamp portion 120 of the device is remotely controlled by a wristband 400. More specifically, the wristband 400 includes a transmitter 401 to wirelessly communicate with a receiver 402 located on the lamp device 100 or stand 110. In this embodiment, the lamp device 100 comprises a lamp 120 mounted on a stand 110, a mounting plate 130 mounted on the top of the stand 110 for mounting electronic devices 210, a height adjusting mechanism 112, a rotation adjusting mechanism 114, a switch 160, and wireless communication modules. The lamp device 100 pairs and connects to the wristband 400, such that the wristband 400 enables a user to operate the lamp device 100 remotely via a transmitter 401 and receiver 402. More specifically, the user may utilize the wristband 400 to rotate the mounting plate 130, adjust height of the lamp stand 110, turn ON/OFF the light of the lamp 120, turn ON/OFF charging of a mounted electronic device 210 connected through a USB port 118, etc. Accordingly, the lamp device 100 further comprises a wireless communication module, such as a Bluetooth chipset, Wi-Fi chipset, or the like to wirelessly communicate with the wristband 400.

In an alternate embodiment of the present invention, the modified lamp device 100 can be operated through a compatible software application, installed on any other electronic device. The software application connects the lamp device 100 over a wireless network connection such as Bluetooth, Wi-Fi, or the like to enable or disable different lamp features, such as turn ON/OFF the light source, turn ON/OFF the USB charging feature, change the height of the stand, adjust the viewing angle of the mounted electronic device and/or changing modes of the switch of the lamp device 100. In one embodiment of the present invention, a Wi-Fi LED bulb 122 may be attached to the lamp device 100, and can be manipulated using the wirelessly connected wristband 400 or the software application. For example, in addition to turning the bulb 122 ON or OFF, the wristband 400 (or the software application) can be used to set the color, brightness or other features of the bulb 122 as per the needs of the user.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “lamp device”, “lamp assembly”, “lamp with phone holder and charger” and “modified lamp assembly” are interchangeable and refer to the modified lamp assembly 100 of the present invention. As used herein “mounting plate” or “device holder” are interchangeable and refer to the mounting plate 130 of the modified lamp device 100 for clamping electronic devices of different sizes.

Notwithstanding the forgoing, the modified lamp device 100 of the present invention can be of any suitable size and configuration as is known in the art without affecting the overall concept of the invention, provided that it accomplishes the above stated objectives. One of ordinary skill in the art will appreciate that the size, configuration and material of the modified lamp device 100 as shown in the FIGS. are for illustrative purposes only, and that many other sizes of the modified lamp device 100 are well within the scope of the present disclosure. Although the dimensions of the modified lamp device 100 are important design parameters for user convenience, the modified lamp device 100 may be of any size that ensures optimal performance during use and/or that suits user need and/or preference.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A combination lamp and electronic mounting device comprising;
an illumination source;
a stand having a base and a mounting plate, wherein the base is connected to a first end of the stand and the mounting plate is positioned on an opposite end of the stand, and further wherein the base is larger than the mounting plate;
a first clip and a second clip repositionably disposed on the mounting plate; and
a rotating adjustment mechanism, wherein the rotating adjustment mechanism enables the mounting plate to be rotated about a longitudinal axis of the stand, and tilted up to 90° relative to the longitudinal axis.

2. The combination lamp and electronic mounting device of claim 1, wherein the mounting plate is comprised of a plurality of grooves.

3. The combination lamp and electronic mounting device of claim 2, wherein the mounting plate is comprised of a pair of longitudinal sides and a pair of lateral sides, and further wherein the plurality of grooves are arranged on the mounting plate as one of (a) parallel to the pair of longitudinal sides, (b) diagonal to the pair of longitudinal sides, and (c) perpendicular to the pair of longitudinal sides.

4. The combination lamp and electronic mounting device of claim 1, wherein the mounting plate comprises a gripping surface.

5. The combination lamp and electronic mounting device of claim 4, wherein the gripping surface is selected from a group including a rubber, a polymeric material, and a plastic material.

6. The combination lamp and electronic mounting device of claim 5, wherein the gripping surface has a coefficient of friction for kinetic energy ranging from 0.5μ to 0.8μ.

7. The combination lamp and electronic mounting device of claim 1, wherein the stand is a telescoping housing having a length between 6 inches and 4 feet when fully extended.

8. The combination lamp and electronic mounting device of claim 1, wherein the illumination source is one of a bulb, an LED light, an incandescent light, a florescent light, and a CFL light source.

9. The combination lamp and electronic mounting device of claim 8 further comprising a switch for operating the illumination source.

10. The combination lamp and electronic mounting device of claim 8 further comprising a rechargeable battery.

11. A combination support and smart device accessory comprising:
a smart device having a size and a shape;
a support, the support comprising a housing with a base at one end and a mounting support provided at another end opposite the base, the housing being extendable and retractable via a telescoping adjusting mechanism;
an illumination device connected to the housing;
the support further comprising a USB port and a battery; and
the mounting support having a surface, a first clip and a second clip, wherein the first and second clip defining a space therebetween that is adjustable to accommodate the size and the shape of the smart device, and further wherein the mounting support is repositionable in both a horizontal and a vertical plane relative to the base.

12. The combination support and smart device accessory of claim 11, wherein the surface of the mounting support is comprised of a plurality of grooves and a gripping surface.

13. The combination support and smart device accessory of claim 12, wherein gripping surface is selected from a group including a rubber, a polymeric material, and a plastic material, and further wherein the gripping surface has a coefficient of friction for kinetic energy ranging from 0.5μ to 0.8μ.

14. The combination support and smart device accessory of claim 11 further comprising a wristband having a wireless transmitter for wirelessly communicating with a receiver positioned on the support.

15. The combination support and smart device accessory of claim 14, wherein the wristband can adjust a position of the mounting support relative to the base remotely.

16. The combination support and smart device accessory of claim 12, wherein the mounting support is comprised of a pair of longitudinal sides and a pair of lateral sides, and further wherein the plurality of grooves are arranged on the mounting support as one of (a) parallel to the pair of longitudinal sides, (b) diagonal to the pair of longitudinal sides, and (c) perpendicular to the pair of longitudinal sides.

17. An illumination and smart device holder system comprising:
a smart device;
a wireless wristband having a wireless transmitter;
a holder having a stand with first and second ends, with a base applied at the first end and a mounting support at the second end, the mounting support being adjustable on both of a horizontal plane and a vertical plane relative to a longitudinal axis of the stand;
the stand being adjustable in height and including an illumination source; and
the stand having a wireless receiver to communicate with the transmitter of the wristband and the wristband may be used to adjust the height of the stand and a position of the mounting support in at least one of the horizontal and vertical planes.

18. The illumination and smart device holder system of claim 17, wherein the mounting support comprises a gripping surface which is selected from a group including a rubber, a polymeric material, and a plastic material, and further wherein the gripping surface has a coefficient of friction for kinetic energy ranging from 0.5μ to 0.8μ.

19. The illumination and smart device holder system of claim 18, wherein the gripping surface includes a plurality of grooves.

20. The illumination and smart device holder system of claim 17, wherein the illumination source is one of a bulb, an LED light, an incandescent light, a florescent light, and a CFL light source.
